(19) United States
(12) Patent Application Publication
(10) Pub. No.: US 2025/0379658 A1
(43) Pub. Date: Dec. 11, 2025

(54) RECEIVING DEVICE

(71) Applicant: TOYOTA JIDOSHA KABUSHIKI KAISHA, Toyota-shi Aichi-ken (JP)

(72) Inventors: Shintaro SHIBA, Bunkyo-ku Tokyo-to (JP); Quan KONG, Toshima-ku Tokyo-to (JP); Norimasa KOBORI, Nakano-ku Tokyo-to (JP)

(73) Assignee: TOYOTA JIDOSHA KABUSHIKI KAISHA, Toyota-shi Aichi-ken (JP)

(21) Appl. No.: 19/226,338

(22) Filed: Jun. 3, 2025

(30) Foreign Application Priority Data
Jun. 7, 2024 (JP) 2024-092908

(51) Int. Cl. H04B 10/60; H04B 10/116

(52) U.S. Cl. CPC H04B 10/60; H04B 10/116

(57) ABSTRACT

A receiving device includes an event camera, and a controller configured to receive an optical wireless communication signal through the event camera and to dynamically change settings of the event camera. The controller is further configured to execute a reception determination process to detect or predict reception of the optical wireless communication signal, and a setting change process to automatically change the settings of the event camera to first settings, when the reception of the optical wireless communication signal is detected or predicted.

### CROSS REFERENCE TO RELATED APPLICATION

This application claims priority to Japanese Patent Application No. 2024-092908 filed on Jun. 7, 2024, the entire contents of which are incorporated by reference herein.

### TECHNICAL FIELD

The present disclosure relates to a receiving device used for optical wireless communication.

### BACKGROUND ART

Patent Literature 1 discloses a color variable visible optical communication system. The transmitter generates and transmits optical signals using red, green, and blue LEDs. On the other hand, the receiver includes only one type of photodiode. Since the receiving sensitivity of the photodiode varies depending on light colors, the receiving sensitivity of the photodiode is changed depending on the color of received light. That is, the receiver adjusts the receiving sensitivity according to the color of the light of the LED that transmits the signal.

### LIST OF RELATED ART

Patent Literature 1: Japanese Laid-Open Patent Application No. 2009-111474

### SUMMARY

In optical wireless communication, a case where a receiver receives an optical wireless communication signal through an event camera will be considered. Since the usage of the event camera is not necessarily limited to the optical wireless communication, default settings of the event camera are not necessarily suitable for the optical wireless communication.

The present disclosure aims to provide a technique for automatically changing the settings of the event camera so as to flexibly adapt to the surrounding situation.

A first aspect relates a receiving device.

The receiving device includes an event camera and a controller configured to receive an optical wireless communication signal through the event camera and to dynamically change settings of the event camera.

The controller is further configured to execute:
a reception determination process to detect or predict reception of the optical wireless communication signal; and
a setting change process to automatically change the settings of the event camera to first settings, which is for the optical wireless communication signal and different from default settings, when the reception of the optical wireless communication signal is detected or predicted.

According to the first aspect, the controller included in the receiving device appropriately changes the settings of the event camera by executing the reception determination process and the setting change process. That is, when the reception of the optical wireless communication signal is detected or predicted in the reception determination process, the setting change process is executed. Through the setting change process, the controller changes the settings of the event camera to the first settings that are more suitable for receiving the optical wireless communication signal than the default settings. This allows the receiving device to properly receive the optical wireless communication signal.

### BRIEF DESCRIPTION OF DRAWINGS

FIG. 1 is a diagram showing an overview of an optical wireless communication system according to the present embodiment;

FIG. 2A is a schematic diagram showing an example of a reception determination process;

FIG. 2B is another schematic diagram showing an example of a reception determination process;

FIG. 3 is a graph showing data frequency characteristics of an optical signal and noise;

FIG. 4 is a graph for explaining a second example of the reception determination process;

FIG. 5 is a schematic diagram showing a third example of the reception determination process;

FIG. 6 is a graph for explaining sensor sensitivity adjustment;

FIG. 7 is a graph for schematically explaining an adjustment of a refractory period;

FIG. 8A is a graph for schematically explaining a default setting process;

FIG. 8B is another graph for schematically explaining a default setting process;

FIG. 9 is a flowchart summarizing a flow of a series of processes;

FIG. 10 is a block diagram showing an example of the configuration of the optical wireless communication system.

### DETAILED DESCRIPTION

Embodiments of the present disclosure will be described with reference to the drawings.

### 1. BASIC CONFIGURATION

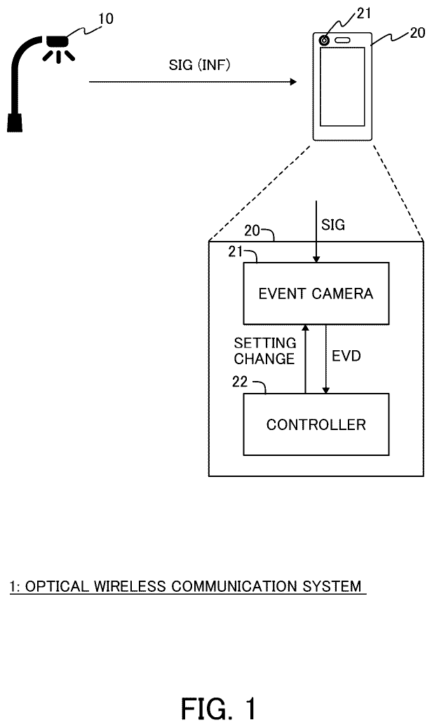

FIG. 1 is a diagram showing an overview of an optical wireless communication system 1 according to the present embodiment. The optical wireless communication system 1 includes an optical source 10 and a receiving device 20. The receiving device 20 includes an event camera 21 and a controller 22.

The optical source 10 can be installed indoors or outdoors. Examples of the optical source 10 include a visible light emitting diode (LED) and an infrared LED. Since the visible light LED is widely used for streetlights, interior lights, traffic signals, electric bulletin boards, and the like, the use of the visible light LED in the optical wireless communication system 1 leads to effective utilization of existing facilities. Since the visible light LED blinks at a high speed that cannot be sensed by human eyes, the visible light can be used as a communication signal by controlling the blinking. A wireless communication method using light is called optical wireless communication.

The optical source 10 transmits an optical wireless communication signal SIG by blinking. Hereinafter, the “optical wireless communication signal SIG” is simply referred to as an “optical signal SIG” to simplify the explanation. The optical signal SIG carries signal information INF. The signal information INF is information expressed by the blinking pattern of the optical source 10, and includes, for example, absolute position information and identification information of the optical source 10.

The receiving device 20 is mounted on a portable terminal such as a smartphone or a tablet, or an augmented reality terminal. Examples of the augmented reality terminal include augmented reality goggles and glasses to be worn on the face. The displays of augmented reality terminals display real images and digital information (text, 3D avatars, other images, etc.) in an overlapping way. In addition to these examples, the receiving device 20 can be mounted on a vehicle, a robot, a wheelchair, a walking stick, etc.

The event camera 21 includes an event-based vision sensor (hereinafter referred to as an event sensor). The event sensor observes luminance changes received by pixels (image sensors) in the event sensor. When observing a luminance change equal to or greater than a preset threshold, the event sensor detects the luminance change as an “event”. The event is detected when a situation different from the previous situation occurs. For example, when an object or the event camera 21 moves, the relative position between the object and the event camera 21 changes and the object appears in pixels where the object has not existed. In such a case, a significant luminance change occurs in pixels around the object, and thus an event is detected. In addition, the optical signal SIG is also detected as an event because the optical signal SIG causes a luminance change in accordance with the blinking of the optical source 10.

The event camera 21 outputs the event data EVD for the pixel in which the event is detected. The event data EVD includes at least coordinates on an image plane of the pixel where the event occurred, the time when the event was detected, and a light and dark polarity (positive/negative). The threshold value referred to by the event sensor when detecting a luminance change is set to be changeable. When an event occurs, a threshold on the positive side (change in the bright direction) and a threshold on the negative side (change in the dark direction) are set based on a voltage (reference voltage) with reference to the luminance level at that time. A voltage change exceeding the threshold on the positive side is detected as an event of positive polarity, and a voltage change exceeding the threshold on the negative side is detected as an event of negative polarity. That is, the optical signal SIG is detected by the event sensor as a positive event when the optical source 10 is turned on and as a negative event when the optical source 10 is turned off.

The controller 22 acquires the event data EVD from the event camera 21. The controller 22 can recognize the optical signal SIG by extracting a component corresponding to the optical signal SIG from the event data EVD. That is, the controller 22 can receive the optical signal SIG through the event camera 21. Further, the controller 22 acquires signal information INF by demodulating the received optical signal SIG. The optical signal SIG (signal information INF) can be used for a variety of purposes. For example, when the optical signal SIG (signal information INF) includes absolute position information of the optical source 10, the controller 22 uses the absolute position information of the optical source 10 obtained from the optical signal SIG to estimate the absolute position and orientation of the event camera 21.

In optical wireless communication, there are settings of event camera 21 suitable for receiving an optical signal SIG (i.e., light that blinks at a high speed). However, the use of the event camera 21 is not necessarily limited to the optical wireless communication. For example, when a vehicle is traveling within the view of the event camera 21, the luminance of the pixels of the event sensor changes due to the movement of the vehicle. As a result, the event sensor detects the movement of the vehicle as an event. Thus, detecting a moving object is another application of event camera 21. Therefore, it is not necessarily desirable that the settings of the event camera 21 are fixed in a state suitable for the optical signal SIG. Therefore, in the present embodiment, a technique is disclosed in which the controller 22 automatically changes the settings of the event camera 21 depending on circumstances.

The controller 22 appropriately changes the settings of the event camera 21 by executing a “reception determination process” and a “setting change process”. The reception determination process is a process that detects or predicts the reception of the optical signal SIG by the event camera 21. The setting change process is a process that changes the settings of the event camera 21 to “first settings” for the optical signal SIG different from the default settings, when the reception of the optical signal SIG by the event camera 21 is detected or predicted. With these processes, even when the event camera 21 included in the receiving device 20 is used for a variety of purposes, the optical signal SIG can be appropriately received at least during the optical wireless communication. The series of processes will be described in detail below.

### 2. RECEPTION DETERMINATION PROCESS

The reception determination process determines whether the receiving device 20 is currently receiving the optical signal SIG or is likely to receive the optical signal SIG in the future. When it is determined that the receiving device 20 is currently receiving the optical signal SIG or is likely to receive the optical signal SIG in the future, the controller 22 executes the setting change process to change the setting of the event camera 21 to the first settings for receiving the optical signal SIG. In other words, the reception determination process is a trigger for determining whether or not to execute the subsequent setting change process.

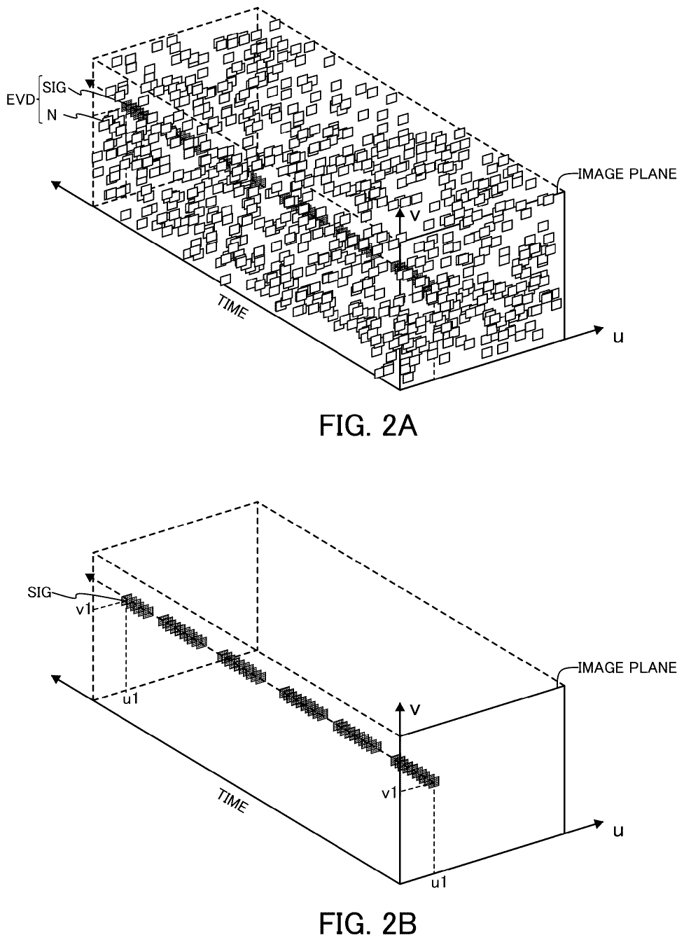

FIGS. 2A-2B are schematic diagrams showing an example of the reception determination process. FIG. 2A is a graph showing the space-time distribution of the event data EVD received by the controller 22 from the event camera 21. The event data EVD includes noise N, which is an event caused by the movement of an object or the event camera 21, in addition to the event caused by the blinking of the optical source 10 (that is, the optical signal SIG).

### 2-1. First Example

In the first example of the reception determination process, the controller 22 executes “signal separation”, which is a process of separating the optical signal SIG and the noise N in order to detect the reception of the optical signal SIG. One method of signal separation is based on “data frequency” of the event data EVD for each pixel. As described above, the event data EVD includes the time at which the event is detected. Therefore, the controller 22 can calculate the number of event data EVD detected per unit time for each pixel. The data frequency indicates the number of event data EVD detected per unit time.

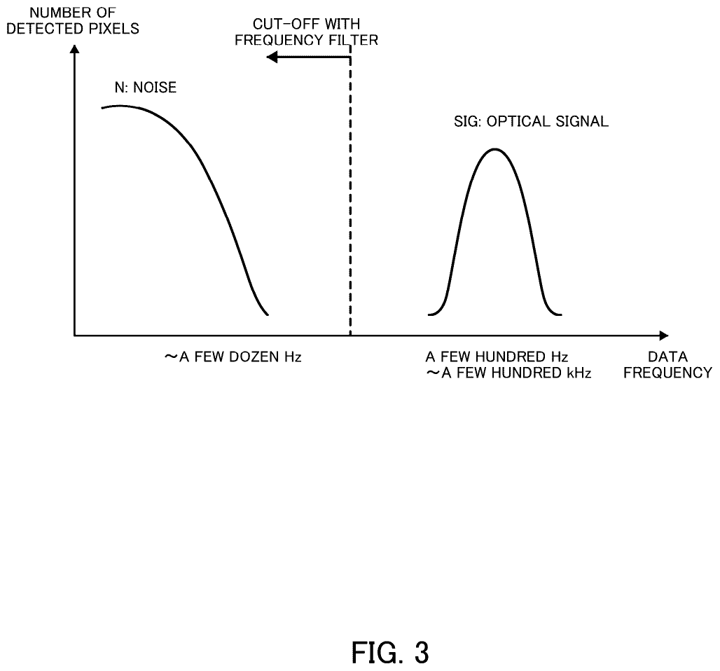

FIG. 3 is a graph showing data frequency characteristics of the optical signal SIG and the noise N. The vertical axis represents the number of pixels detected by the event sensor. The horizontal axis represents data frequency. The graph shows the data frequency characteristics of the optical signal SIG and that of the noise N are significantly different. The optical signal SIG has a value of about a few hundred Hz to a few hundred kHz. On the other hand, the noise N caused by the motion of the object or the event camera 21 is significantly smaller than the optical signal SIG (about a few dozen Hz). Therefore, the controller 22 can separate the optical signal SIG and the noise N by using a frequency filter. An example of the frequency filter is a high-pass filter that cuts off a signal having a frequency equal to or lower than a preset frequency. In this case, the controller 22 determines that the event camera 21 has received the optical signal SIG when detecting a high data frequency that is not cut by the high-pass filter.

FIG. 2B is a graph showing the space-time distribution of the event data EVD after signal separation. With the signal separation, the optical signal SIG can be extracted from the event data EVD. As described above, the event data EVD includes information on coordinates (u1 and v1 in the drawing) on the image plane. Therefore, in the first example, the controller 22 can detect the reception of the optical signal SIG and acquire the position of the optical signal SIG on the image plane.

### 2-2. Second Example

In the second example, unlike the first example, the data frequency of each pixel of the event data EVD is not used. In the second example, the reception determination process is executed based on a change in the total amount of the event data EVD (event data amount) detected by all the pixels of the event camera 21. When the optical signal SIG is received, a large number of events are detected in a short period due to the high-speed blinking of the optical source 10, and thus the amount of event data should increase significantly.

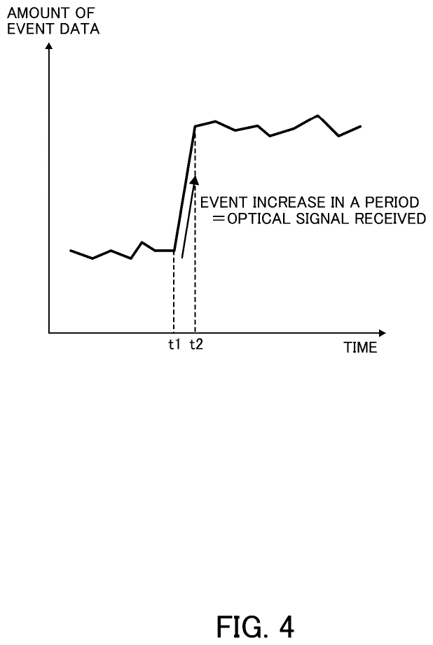

FIG. 4 is a graph for explaining a second example of the reception determination process. The vertical axis and the horizontal axis of the graph indicate the amount of event data and time, respectively. For example, in FIG. 4, the amount of event data significantly increases from time t1 to time t2. On the other hand, before t1 and after t2, no significant change is observed in the event data amount. In such a case, the controller 22 determines that the optical signal SIG is received by the event camera 21 on the basis of the increase in the amount of event data in the period from t1 to t2. For example, when the amount of event data increases by a predetermined value or more within a predetermined period, it is determined that the optical signal SIG has been received. The changing rate for the amount of event data and the length of the reference period, which are the basis of the determination, can be arbitrarily set.

### 2-3. Third Example

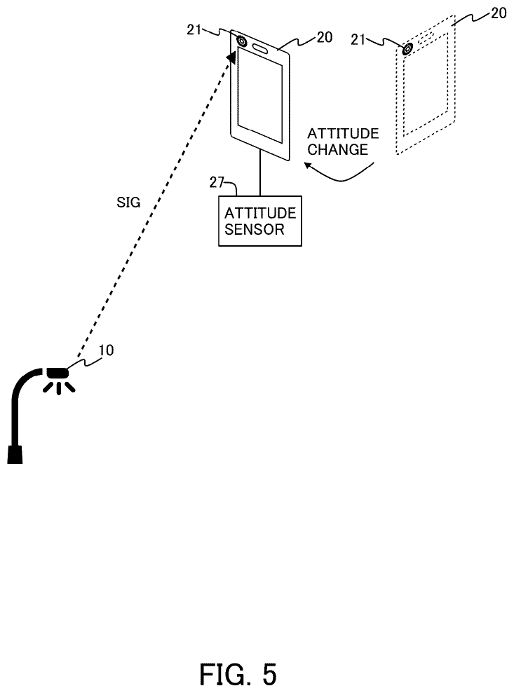

FIG. 5 is a schematic diagram showing a third example of the reception determination process. In a third example, the controller 22 predicts the reception of the optical signal SIG based on a change in the attitude of the receiving device 20. When a user of the receiving device 20 utilizes optical wireless communication, the receiving device 20 is often directed toward the optical source 10 in order to capture the optical source 10 in the view of the event camera 21. That is, a characteristic change in the attitude of the receiving device 20 often occurs immediately before the optical wireless communication begins. The attitude of the receiving device 20 is acquired by an attitude sensor 27. For example, a gyroscope that detects an azimuth or an angular velocity, a three-axis acceleration sensor, etc. are used as the attitude sensor 27. The controller 22 receives information on the attitude of the receiving device 20 from the attitude sensor 27 and predicts the reception of the optical signal SIG based on the change in the attitude.

Since the reception determination process according to the third example is a predicting process based on the attitude change of the receiving device 20, there may be a case where the prediction is wrong (that is, the optical signal SIG is not actually received). However, if the setting change process is started at the timing when the attitude change is detected, the setting of the event camera 21 is changed to the first settings earlier than the first and second examples. That is, the optical wireless communication is started earlier by regarding the attitude change of the receiving device 20 as a sign that the event camera 21 receives the optical signal SIG.

### 3. SETTING CHANGE PROCESS

The setting change process is executed when it is determined in the reception determination process that the optical signal SIG is currently received or is likely to be received in the future. The setting change process changes the setting of the event camera 21 from the default settings to the first settings, which are more suitable for receiving the optical signal SIG. Some specific examples of the setting change process will be described below.

### 3-1. Sensor Sensitivity Adjustment

An example of the setting change process is “sensor sensitivity adjustment”. The sensor sensitivity is a threshold value for the luminance change amount used when the event sensor detects events. When a certain value of sensor sensitivity is set, the event camera 21 detects a luminance change equal to or greater than the set value as an event.

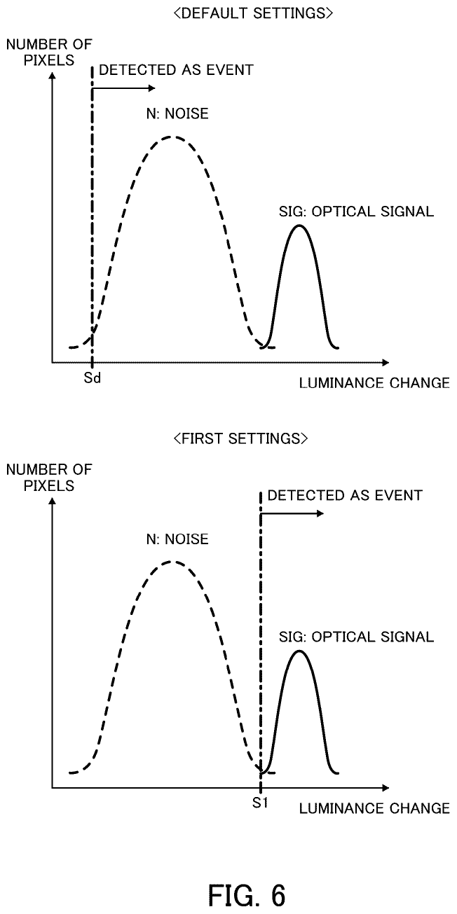

FIG. 6 is a graph for explaining the sensor sensitivity adjustment as an example of the setting change process. The graph shows the distribution of the number of pixels in which the luminance change, represented by the horizontal axis, is observed, among all the pixels of the event camera 21. The intensity of the luminance change is significantly different between the luminance change caused by the movement of the object (i.e., noise N) and the luminance change caused by the blinking of the artificial optical source 10 (i.e., optical signal SIG). As shown in FIG. 6, the luminance change caused by the optical signal SIG is larger than the luminance change caused by the noise N. The controller 22 changes the setting of the event camera 21 to the first settings adjusted for the optical signal SIG based on the difference in the distribution of the luminance change.

In FIG. 6, at default sensor sensitivity Sd in the default settings, a luminance change equal to or greater than the default sensor sensitivity Sd is detected as an event. That is, the noise N is also detected as an event together with the optical signal SIG. On the other hand, first sensor sensitivity S1 in the first settings is set to be lower (less sensitive) than the default sensor sensitivity Sd. That is, in the first settings, only the luminance change equal to or greater than the first sensor sensitivity S1 is detected, and thus the optical signal SIG is still detected, but the noise N is hardly detected. As a result, the optical signal SIG is detected relatively more than the noise N, and thus the signal-to-noise ratio (S/N ratio) is improved.

In communication with a low S/N ratio, the amount of detected data exceeds the communication capacity because the noise N is relatively large, possibly resulting in loss of the optical signal SIG necessary for communication during communication. That is, the default sensor sensitivity Sd that detects a large amount of noise N is not suitable for optical wireless communication. On the other hand, changing the default sensor sensitivity Sd to the first sensor sensitivity S1 by the sensor sensitivity adjustment reduces the amount of information since the noise N is less likely to be detected, and thus the loss of the optical signal SIG can be prevented. The reduction in the amount of data also contributes to a reduction in processing load, memory usage, or power consumption.

Lowering the sensor sensitivity is synonymous with increasing the bias. Since event sensor does not detect luminance changes smaller than the bias setting, bias can be a measure to show how unresponsive the event sensor is.

In the sensor sensitivity adjustment, the controller 22 may gradually reduce the sensor sensitivity. For example, the controller 22 gradually reduces the sensor sensitivity until the detected amount of the event other than the optical signal SIG becomes equal to or less than a threshold value set in advance. Thus, the detected amount of the optical signal SIG is relatively increased, resulting in higher S/N ratio.

### 3-2. Adjustment of Refractory Period

As another example of the setting change process, a process to shorten a “refractory period” of the event camera 21 (event sensor) is exemplified. The pixel of the event sensor which has once detected the event does not respond to the event for a short time thereafter. This period is called a refractory period. As described above, the optical signal SIG is expressed by high-speed blinking (ON/OFF switching) of the optical source 10. Therefore, in order to properly receive the optical signal SIG, the refractory period needs to be set to be sufficiently short. On the other hand, setting the refractory period to be unnecessarily short results in excessive detection of the event data EVD, which leads to an increase in the amount of data and the processing load. Therefore, it is desirable that the refractory period is set to be relatively long (for example, about 10 to tens of microseconds) in the default settings, and the refractory period is set to be relatively short (for example, the lower limit value of the event sensor, e.g. 1 microsecond) in the first settings for the optical signal SIG.

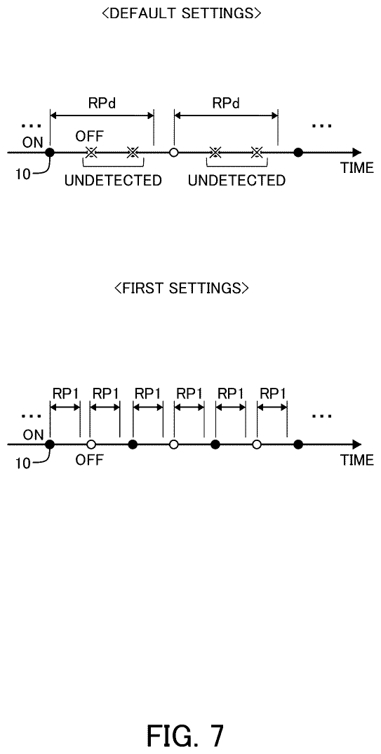

FIG. 7 is a graph for schematically explaining the adjustment of the refractory period. The axis of the graph represents time. A black circle on the axis indicates the turn-on (ON) of the optical source 10, and a white circle indicates the turn-off (OFF) of the optical source 10. That is, the graph shows the blinking of the optical source 10 in time series. In the default settings, the refractory period of the event camera 21 is set to the default refractory period RPd. When the event camera 21 receives the optical signal SIG with the default settings, the event camera 21 cannot detect the ON/OFF switching of the optical source 10 that occurs during the default refractory period RPd. This indicates that a part of the optical signal SIG is not properly detected. On the other hand, in the first settings, the refractory period is set to the first refractory period RP1. The first refractory period RP1 is shorter than the default refractory period RPd, and is set so that the ON/OFF switching of the optical source 10 can be properly detected. Thus, the event camera 21 can detect the optical signal SIG more accurately.

### 3-3. Combination

It is also effective to combine the sensor sensitivity adjustment and the refractory period adjustment described above. In this case, the controller 22 sets the first sensor sensitivity S1 to be smaller than the default sensor sensitivity Sd and sets the first refractory period RP1 to be shorter than the default refractory period RPd. Shortening the refractory period enables accurate detection of the optical signal SIG, meanwhile more event data EVD (including noise N) is detected compared to the default settings. Therefore, if the sensor sensitivity adjustment is used together to reduce the amount of data to be detected, the disadvantages of the increase in the amount of data and the processing load are canceled while the detection speed is increased with a short refractory period.

### 4. OTHER PROCESSES

### 4-1. Default Setting Process

In some embodiments, the first settings set by the setting change process are reset to the default settings when the event camera 21 does not receive the optical signal SIG any longer. In the reception determination process, when the reception of the optical signal SIG is detected or predicted, the controller 22 changes the setting parameter of the event camera 21 from the default settings to the first settings for the optical signal SIG. Even after the settings of the event camera 21 is switched to the first settings, the controller 22 continues the reception determination process. When the reception of the optical signal SIG is not detected or predicted, the controller 22 returns the setting of the event camera 21 from the first settings to the default settings. Hereinafter, the process in which the controller 22 returns the setting of the event camera 21 from the first settings to the default settings is referred to as a “default setting process”.

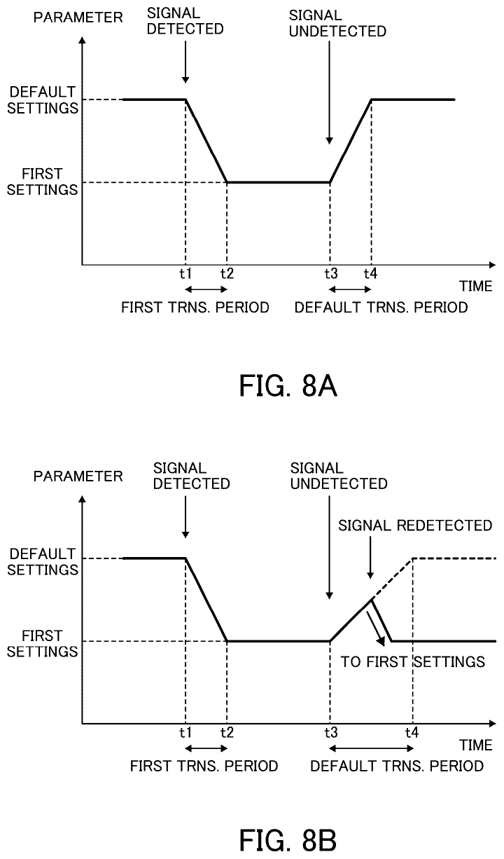

FIGS. 8A-B are graphs for schematically explaining the default setting process. The vertical axis of the graph indicates the value of a setting parameter (e.g., sensor sensitivity or refractory period) constituting the settings of the event camera 21. The horizontal axis of the graph represents time. The settings of event camera 21 are the default settings until t1. When the reception of the optical signal SIG is detected or predicted at t1, the setting parameter of the event camera 21 is changed from the default settings to the first settings over the period from t1 to t2. Between t2 and t3, the reception of the optical signal SIG is detected or predicted by the reception determination process, and thus the settings are maintained to be the first settings. At t3, the reception of the optical signal SIG is not detected or predicted, and thus the controller 22 reset the setting of the event camera 21 from the first settings to the default settings over the period from t3 to t4.

The period of time for the transition from the first settings to the default settings in the default setting process (default transition period) may be set to be longer than the period of time for the transition from the default settings to the first settings in the setting change process (first transition period). FIG. 8A, the default transition period is equal to the first transition period; FIG. 8B, the default transition period is longer than the first transition period. With such a setting, when the controller 22 detects or predicts the reception of the optical signal SIG again during the default transition period, the controller 22 can quickly return the settings to the first settings. That is, even when the optical wireless communication is intermittently generated, the controller 22 can quickly respond to the optical signal SIG.

### 4-2. Flowchart

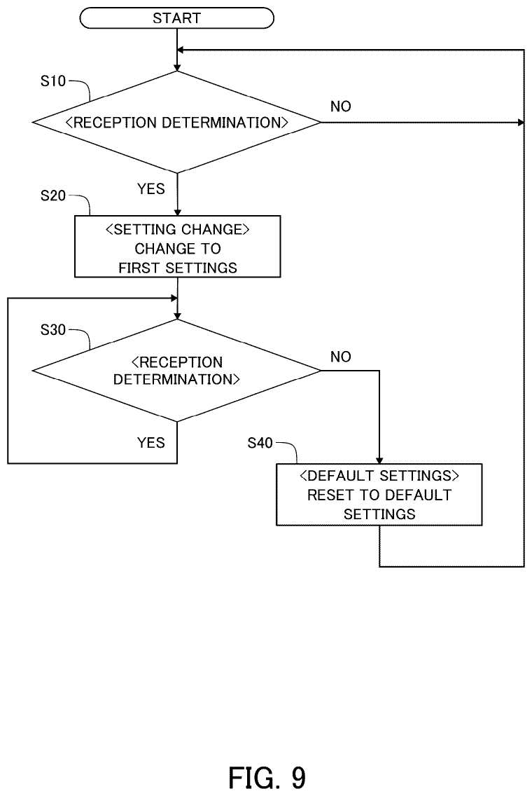

FIG. 9 is a flowchart summarizing the flow of the series of processes described so far. At the start of the process, the event camera 21 is set to the default settings.

In step S10, the controller 22 executes a reception determination process. The controller 22 determines whether reception of the optical signal SIG is detected or predicted. If the reception of the optical signal SIG is detected or the reception is predicted (step S10; YES), the process proceeds to step S20. If the optical signal SIG is neither received nor predicted (step S10; NO), the process repeats step S10.

In step S20, the controller 22 executes the setting change process. That is, the controller 22 changes the setting of the event camera 21 from the default settings to the first settings. The first settings is a setting more suitable for reception of the optical signal SIG. Thereafter, the process proceeds to step S30.

In step S30, the controller 22 executes the reception determination process. If the optical signal SIG is received or the reception is predicted (step S30; YES), the process repeats step S30. If the reception of the optical signal SIG is neither detected nor predicted (step S30; NO), the process proceeds to step S40.

In step S40, the controller 22 executes the default setting process. That is, the controller 22 resets the setting of the event camera 21 from the first settings to the default settings. Thereafter, the process returns to step S10.

Through such a series of processing, the controller 22 automatically changes the setting of the event camera 21 to adjust to circumstances.

### 5. CONFIGURATION EXAMPLE

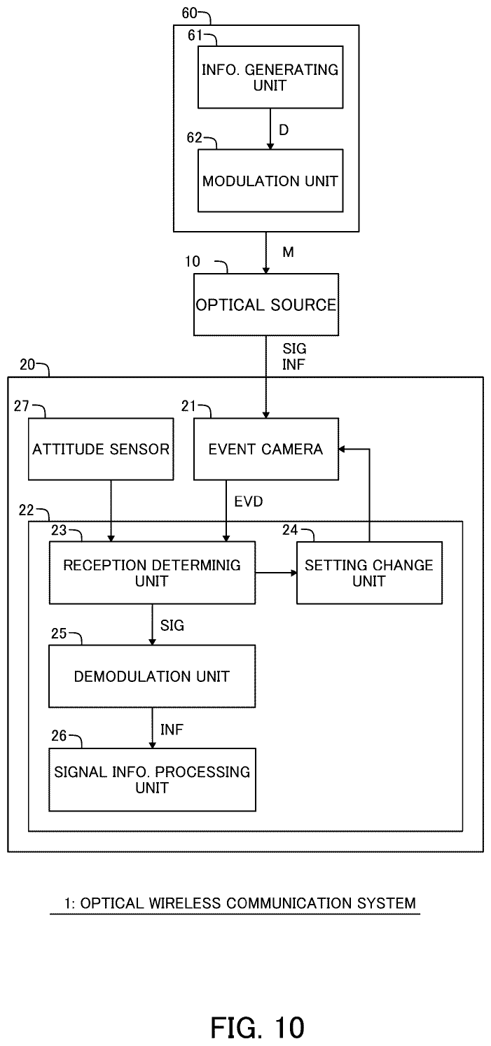

FIG. 10 is a block diagram illustrating an example of a configuration of the optical wireless communication system 1.

A blinking control device 60 controls the blinking pattern of the optical source 10. The blinking control device 60 may be built in each equipment (streetlight, room light, etc.) including the optical source 10. The blinking control device 60 may be included in external equipment (for example, a management server), and may control the blinking of the optical source 10 remotely.

An information generating unit 61 generates a digital signal D. The digital signal D is a binary signal representing the signal information INF with two values: 0/1. The signal information INF is information transmitted by the optical signal SIG, and includes, for example, absolute position information and identification information of the optical source 10. The generated digital signal D is output to a modulation unit 62.

The modulation unit 62 generates a modulated signal M by modulating the digital signal D into a signal suitable for optical wireless communication. As the modulation method, a pulse width modulation (PWM) method, a pulse position modulation (PPM) method, etc. can be used. The PWM method is a method of changing the time ratio between ON (lighting) and OFF (extinction) of the optical source 10 by an input signal. The PPM method is a method in which the position of a carrier pulse on the time axis is changed by an input signal.

The blinking control device 60 passes the modulated signal M to the optical source 10. The optical source 10 blinks in accordance with the modulated signal M. The optical signal SIG is a signal generated by the blinking pattern of the optical source 10 represented by the modulated signal M.

The receiving device 20 receives the optical signal SIG through the event camera 21. Specifically, the event sensor built in the event camera 21 detects luminance changes generated by the optical signal SIG as events. The receiving device 20 transmits the event data EVD to the reception determining unit 23 in the controller 22.

The reception determining unit 23 performs the above-described reception determination process. The reception determining unit 23 transmits the result of the reception determination process to a setting change unit 24.

The setting change unit 24 executes the setting change process and the default setting process described above. When the event camera 21 is under the default settings, if the reception of the optical signal SIG is detected or predicted, the setting change unit 24 executes the setting change process (change from the default settings to the first settings). In addition, in a case where the reception of the optical signal SIG is neither detected nor predicted when the event camera 21 is under the first settings, the setting change unit 24 executes the default setting process (change from the first settings to the default settings).

When the reception determining unit 23 executes the process of separating the optical signal SIG and the noise N included in the event data EVD (the above-described signal separation), the separated optical signal SIG is transmitted to a demodulation unit 25. The demodulation unit 25 demodulates the optical signal SIG separated by the reception determining unit 23 to acquire the signal information INF. The demodulation unit 25 passes the signal information INF to a signal information processing unit 26.

The signal information processing unit 26 executes a variety of processes based on the signal information INF. For example, when the signal information INF includes the absolute position information of the optical source 10, the signal information processing unit 26 can use the absolute position information of the optical source 10 to estimate the absolute position and direction of the event camera 21.

The receiving device 20 may include the attitude sensor 27. The attitude sensor 27 detects the attitude of the receiving device 20. The reception determining unit 23 acquires the attitude information of the receiving device 20 detected by the attitude sensor 27. The reception determining unit 23 uses the attitude information of the receiving device 20 to predict the reception of the optical signal SIG.

What is claimed is:

1. A receiving device comprising:
an event camera; and
a controller configured to receive an optical wireless communication signal through the event camera and to dynamically change settings of the event camera, wherein
the controller is further configured to execute:
a reception determination process to detect or predict reception of the optical wireless communication signal; and
a setting change process to automatically change the settings of the event camera to first settings, which is for the optical wireless communication signal and different from default settings, when the reception of the optical wireless communication signal is detected or predicted.

2. The receiving device according to claim 1, wherein
the settings of the event camera include sensitivity of the event camera, and
the sensitivity in the first settings is lower than the sensitivity in the default settings.

3. The receiving device according to claim 2, wherein
the setting change process includes reducing the sensitivity of the event camera from the sensitivity in the default settings until a detected amount of a signal other than the optical wireless communication signal becomes equal to or less than a threshold.

4. The receiving device according to claim 1, wherein
the settings of the event camera include a refractory period of the event camera, and
the refractory period in the first settings is shorter than the refractory period in the default settings.

5. The receiving device according to claim 1, wherein
the settings of the event camera include sensitivity and a refractory period of the event camera,
the sensitivity in the first settings is lower than the sensitivity in the default settings, and
the refractory period in the first settings is shorter than the refractory period in the default settings.

6. The receiving device according to claim 1, wherein
the controller is further configured to execute a default setting process to switch the settings of the event camera from the first settings to the default settings, when the reception of the optical wireless communication signal is neither detected nor predicted while the settings of the event camera are the first settings.

7. The receiving device according to claim 6, wherein
a period of time for shifting from the first settings to the default settings in the default setting process is longer than a period of time for shifting from the default settings to the first settings in the setting change process.

8. The receiving device according to claim 1, wherein
the reception determination process includes detecting the reception of the optical wireless communication signal based on event data representing a luminance change detected by the event camera.

9. The receiving device according to claim 8, wherein
the reception determination process further includes detecting the reception of the optical wireless communication signal based on a frequency of the event data generated in each pixel of the event camera.

10. The receiving device according to claim 8, wherein
the reception determination process further includes detecting the reception of the optical wireless communication based on a change in an amount of the event data observed in all pixels of the event camera.

11. The receiving device according to claim 1, further comprising an attitude sensor that detects an attitude of the receiving device, wherein
the reception determination process includes predicting the reception of the optical wireless communication signal based on a change in the attitude of the receiving device.

12. The receiving device according to claim 1, wherein
the receiving device is mounted on a portable terminal or an augmented reality terminal.
